(19) United States
(12) Patent Application Publication
(10) Pub. No.: US 2026/0044713 A1
(43) Pub. Date: Feb. 12, 2026

(54) MULTI-HOP QUESTION ANSWER RETRIEVAL AND REASONING FOR LARGE LANGUAGE MODELS

(71) Applicant: International Business Machines Corporation, Armonk, NY (US)

(72) Inventors: Thomas Andre Maxime Carta, Bordeaux (FR); Daiki Kimura, Midori-ku (JP); DON JOVEN RAVOY AGRAVANTE, Yamato (JP); TAKAAKI TATEISHI, Yamato-shi (JP); TOSHIHIRO TAKAHASHI, Shinagawa-ku (JP); Michiaki Tatsubori, Oiso (JP)

(21) Appl. No.: 18/800,225

(22) Filed: Aug. 12, 2024

(51) Int. Cl. G06N 3/0455

(52) U.S. Cl. CPC G06N 3/0455

(57) ABSTRACT

Mechanisms are provided for answering a multi-hop question. The mechanisms extract one or more entities included in the multi-hop question and generate, for each entity, a plurality of sub-questions to help answer the multi-hop question. The mechanisms obtain an answer to each sub-question from a knowledge base to convert each pair of the answer and the sub-question into each affirmative sentence. The mechanisms generate one or more reasoning sentences to answer the multi-hop question by using one or more affirmative sentences and determine whether the multi-hop question is answerable or not by using the one or more reasoning sentences. The mechanisms, in response to a positive determination, output an answer to the multi-hop question by using the one or more affirmative sentences and the one or more reasoning sentences.

### BACKGROUND

The present application relates generally to an improved data processing apparatus and method and more specifically to an improved computing tool and improved computing tool operations/functionality for generating answers to multi-hop questions for large language models.

Large language models are a class of artificial intelligence (AI) models in which machine learning training of natural language processing based deep learning computer models is used to interpret input natural language content and output human-like language responses based on large amounts of text data. These deep learning computer models are transformer models, i.e., a neural network having an encoder and a decoder with self-attention capabilities, which can learn context and relationships between elements in a sequence due to the use of word embeddings. LLMs require a large amount of training data in order to be trained, but can learn to understand basic grammar, languages, and knowledge. These transformer based LLMs can operate on very large numbers of parameters, e.g., billions of parameters, and thus, can ingest very large amounts of data, e.g., data available on the Internet, or the like.

LLMs are trained to be applicable to a variety of different domains and thus, are very flexible. While flexible, LLMs may not provide satisfactory performance for certain domains due to their more general applicability.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a computer-implemented method, in a data processing system, is provided for answering a multi-hop question by an artificial intelligence (AI) computer model. The computer-implemented method is executed by a multi-hop question answer retrieval and reasoning (MQARR) system associated with the AI computer model. The method comprises extracting, by an entity extractor of the MQARR system, one or more entities included in the multi-hop question, and generating, by a question generator of the MQARR system, for each entity, a plurality of sub-questions to assist answering the multi-hop question. The method further comprises obtaining, from the AI computer model, for each sub-question for each entity, a corresponding answer to the sub-question from a knowledge base, and converting, by an affirmative sentence generator of the MQARR system, each pair of sub-question and corresponding answer to a corresponding affirmative sentence for the pair, to thereby generate a plurality of affirmative sentences. The method also comprises generating, by a reasoning sentence generator of the MQARR system, one or more reasoning sentences to answer the multi-hop question based on the plurality of affirmative sentences. Moreover, the method comprises determining, by the MQARR system, whether the multi-hop question is answerable or not based on the one or more reasoning sentences. In addition, the method comprises, in response to determining that the multi-hop question is answerable based on the one or more reasoning sentences, generating, by the MQARR system, an answer to the multi-hop question based on the one or more affirmative sentences and the one or more reasoning sentences.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1A is an example diagram illustrating examples of multi-hop questions for various different types of reasoning;

FIG. 1B is an example diagram illustrating the answering of a multi-hop question by large language models;

FIG. 2 is an example diagram of a distributed data processing system environment in which aspects of the illustrative embodiments may be implemented and at least some of the computer code involved in performing the inventive methods may be executed;

FIG. 3 is an example block diagram of the primary operational components of a multi-hop question answer retrieval and reasoning (MQARR) system in accordance with one illustrative embodiment;

FIGS. 4A-4E are example diagrams illustrating the operation of a multi-hop question answer retrieval and reasoning (MQARR) system with regard to one example original question, in accordance with one illustrative embodiment; and

FIG. 5 is a flowchart outlining an example operation of a multi-hop question answer retrieval and reasoning (MQARR) system in accordance with one illustrative embodiment.

### DETAILED DESCRIPTION

The illustrative embodiments provide an improved computing tool and improved computing tool operations/functionality for generating answers to multi-hop questions for large language models. A “multi-hop” question is a type of question where the answer to that question is not explicitly provided in a single source. That is, a question such as, “What is the elevation of Denver, Colorado?” can be answered from a single source that may specify statistics for Denver, Colorado, i.e., an electronic document, e.g., web page or the like, that states that “Denver, Colorado has an elevation of 5,279 feet”. However, a question such as “Who lived longer, Theodor Haecker or Harry Vaughan Watkins?” is not likely to be able to be answered from a single source document, i.e., it is unlikely that there is an electronic document that explicitly states “Theodor Haecker lived longer than Harry Vaughn Watkins.”

To the contrary, in order to answer this question, one must know how long each person lived, i.e., what day and year that they died, which may require obtaining information from one source specifying the death date of Theodor Haecker and another source specifying the death date of Harry Vaughn Watkins, and then performing a reasoning on these two dates to determine which person lived longer. Moreover, if the question is intended to evaluate the length of life, then the birth dates of each individual may need to be obtained from source documents to determine the lifespans of each individual. This is a simple example of a multi-hop question, meaning that multiple hops of fact gathering followed by reasoning are required to answer the original question. This may become considerably more complicated depending on the complexity of the originally submitted question.

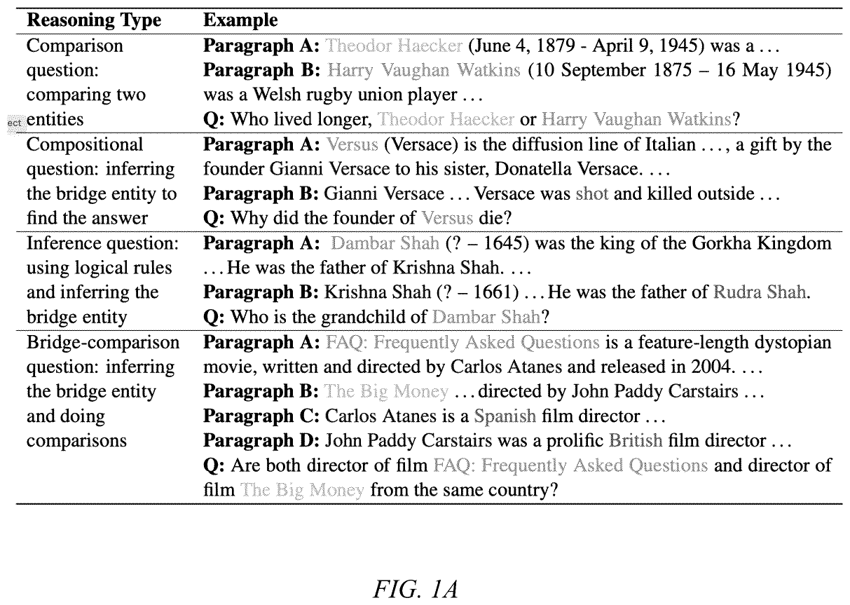

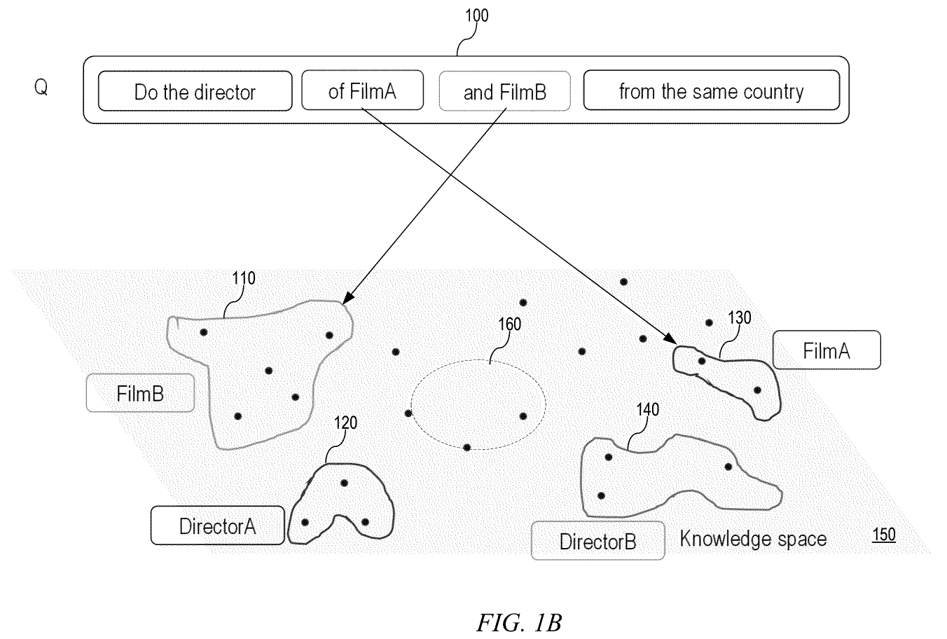

FIG. 1A is an example diagram illustrating examples of multi-hop questions for various different types of reasoning. As shown in FIG. 1A, multi-hop questions arise in various domains and require various types of reasoning to answer them correctly. For example, FIG. 1A shows examples of comparison questions, compositional questions, inference questions, and bridge-comparison questions. Comparison questions require the comparing of two or more entities specified in the question, e.g., in the depicted example comparing features of Theodor Haecker with features of Harry Vaughan Watkins. Compositional questions require inferring the bridge entity to find the answer, e.g., in the depicted example one must determine first whose the founder of Versus was (i.e., the bridge entity), and then determine how that person died, to determine how the founder of Versus died. Inference questions require using logical rules and inferring a bridge entity to answer the question, e.g., in the depicted example, determining who were the children of Dambar Shah and then determining whether those children had children and who they are, so as to determine who the grandchildren of Dambar Shah were. For bridge-comparison questions, answering these questions requires inferring the bridge entity and doing comparisons, e.g., in the depicted example, determining who the directors of the specified films are, determining which countries the directors are from, and then comparing these countries to determine if the countries are the same. As can be seen from FIG. 1A, answering each of these types of questions may require gathering information from a variety of different documents, e.g., paragraphs A, B, C, and D in the various examples.

Artificial Intelligence (AI) computer models, such as Large language models (LLMs), e.g., Generative Pre-trained Transformers (GPT) from OpenAI and the like, are trained for general applicability to a variety of different domains and thus, are able to answer single-hop questions well, but perform poorly for multi-hop questions. This is because such LLMs are trained to try and predict an answer based on the recognized entities and determination of the type of question being asked. This is done by identifying a centralized point within a given knowledge space between the knowledge space elements clustered around the entities.

For example, as shown in FIG. 1B, given an original question 100 of “Do the director of FilmA and FilmB come from the same country?”, an AI computer model may identify the entities in the question, e.g., “director”, “filmA”, “filmB”, and “country”, as well as natural language elements indicating what is being asked, e.g., “come from the same”. Based on the identification of the entities, the AI computing model may identify the corresponding sub-spaces 110, 120, 130, and 140 of a knowledge space 150, e.g., a sub-space 110 having knowledge associated with film B, a sub-space 120 having knowledge associated with director A, a sub-space 130 having knowledge associated with film A, and a sub-space 140 associated with director B. The AI computing model, e.g., the LLM, tries to find an answer that correlates to these sub-spaces which tends to be a central knowledge point between the sub-spaces 110-140, e.g., a point in sub-space 160.

From the above, it can be seen that extracting and exploiting the knowledge from a dataset has a large number of limitations in the case of multi-hop questions because the knowledge retrieval and reasoning operations are entangled. As a result, AI computer models, e.g., LLMs, do not perform well with such multi-hop questions and are more well suited for single-hop questions.

The illustrative embodiments provide an improved computing tool and improved computing tool operations/functionality that is specifically directed to improving answer generation by AI computer models, such as LLMs, specifically for multi-hop questions. The illustrative embodiments operate to disentangle the knowledge retrieval and reasoning operations by providing an intermediary operation that builds a graph of the knowledge relevant for answering the original question by generating a plurality of sub-questions, and processing the plurality of sub-questions to obtain answers that form the relevant knowledge for answering the original question. This relevant knowledge, which may be stored in one or more corresponding data structures, is then used to build a relevant knowledge graph which operates as an structured intermediary search space, as opposed to the unstructured general knowledge space used by the LLM. Once the relevant knowledge graph is built, it is used as a basis for answering the original question.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides an improved question answering system for answering multi-hop questions using a large language model, and thereby improves the operation of large language models for these specific types of questions. The improved computing tool implements mechanism and functionality, such as multi-hop question answer retrieval and reasoning (MQARR) system, which cannot be practically performed by human beings either outside of, or with the assistance of, a technical environment, such as a mental process or the like. The improved computing tool provides a practical application of the methodology at least in that the improved computing tool is able to improve the performance of large language model specifically for multi-hop question answering by providing an additional layer of logic operating with the large language model that specifically tailors inputs and processes outputs of the large language model in a specific manner to cause the large language model to provide more accurate answers to multi-hop questions.

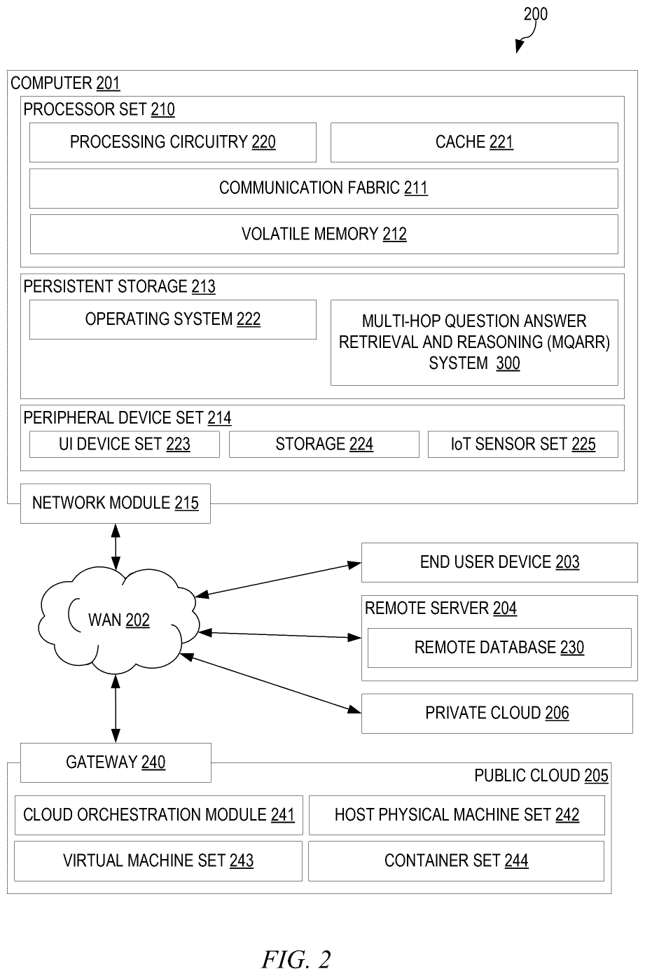

FIG. 2 is an example diagram of a distributed data processing system environment in which aspects of the illustrative embodiments may be implemented and at least some of the computer code involved in performing the inventive methods may be executed. That is, computing environment 200 contains an example of an environment for the execution of at least some of the computer code involved in performing the inventive methods, such as multi-hop question answer retrieval and reasoning (MQARR) system 300. In addition to MQARR system 300, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and MQARR system 300, as identified above), peripheral device set 214 (including user interface (UI), device set 223, storage 224, and Internet of Things (IOT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in MQARR system 300 in persistent storage 213.

Communication fabric 211 is the signal conduction paths that allow the various components of computer 201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, the volatile memory is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface type operating systems that employ a kernel. The code included in MQARR system 300 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE.

Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

As shown in FIG. 2, one or more of the computing devices, e.g., computer 201 or remote server 204, may be specifically configured to implement a multi-hop question answer retrieval and reasoning (MQARR) system 300. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 201 or remote server 204, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates the automatic generation of an intermediary search space from a large knowledge space used by a large language model (LLM), by automatically generating sub-questions and processing these sub-questions to generate answers and build a relevant knowledge tree that can be used to generate affirmative sentences and reasoning sentences which can in turn be used to generate an answer to the original input question.

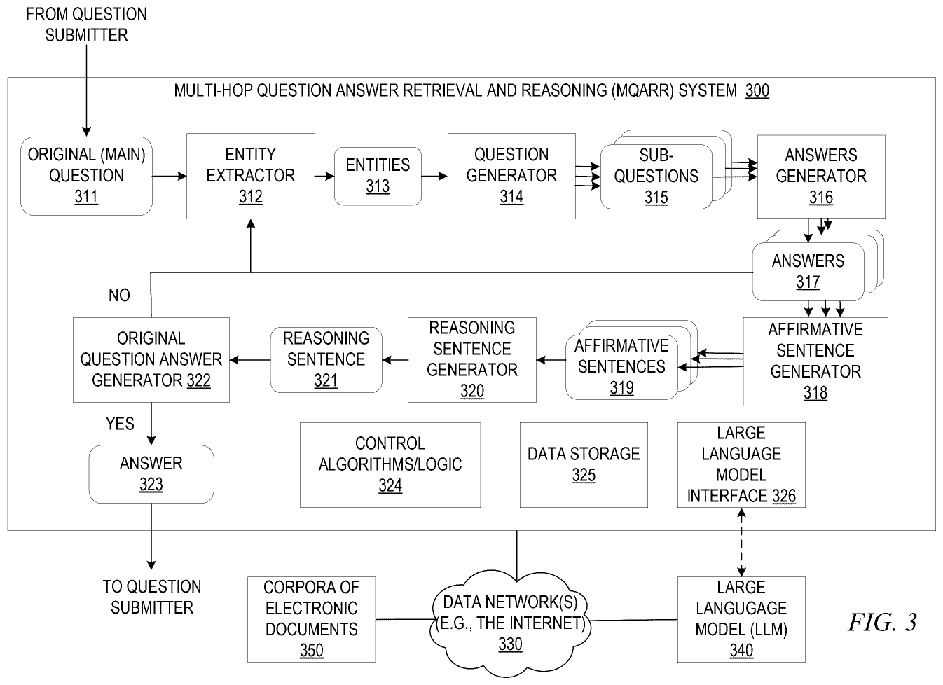

FIG. 3 is an example block diagram illustrating the primary operational components of a multi-hop question answer retrieval and reasoning (MQARR) system in accordance with one illustrative embodiment. The operational components shown in FIG. 3 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., original input questions, and the resulting output may aid human beings, e.g., answers to the original input questions. The invention is specifically directed to the automatically operating computer components directed to improving the way that large language models answer natural language input questions in an automated manner using specific artificial intelligence (AI) computer logic, and providing a specific solution that implements the specific entity extraction, sub-question generation, answer generation, affirmative sentence generation, reasoning sentence generation, and the like, which cannot be practically performed by human beings as a mental process and is not directed to organizing any human activity.

It should be appreciated that while generally human beings are able to mentally answer questions and perform research to answer questions, that is not the focus of the present invention. To the contrary, the present invention is specifically directed to improving the way in which AI computer models automatically answer multi-hop questions that are input to these AI computer models, where in one or more illustrative embodiments these AI computer models are LLMs, e.g., GPT-3, Bidirectional Encoder Representations from Transformers (BERT), Language Model for Dialogue Applications (LaMDA), Orca, Bloom, or other AI computer models operating on large amounts of data. Thus, the invention is computer technology specifically directed to solving problems arising in AI computer models, such as LLMs, and specifically with regard to multi-hop questions (for purposes of illustration, the present description will assume the AI computer model to be an LLM, but the illustrative embodiments are not limited to such). The illustrative embodiments provide a specific computer solution via an improved computing tool that improves the operation of the large language models with regard to the answers generated by the LLMs. The illustrative embodiments specifically improve the performance of such LLMs by improving the accuracy of the answers that are automatically generated via the large language models.

As shown in FIG. 3, the illustrative embodiments provide a multi-hop question answer retrieval and reasoning (MQARR) system 300 that builds a relevant knowledge tree using automatically generated sub-questions and specific patterns of prompting of a LLM 340 which then generates an answer to an original (or main) multi-hop question based on the generated relevant knowledge tree. The MQARR system 300 comprises an entity extractor 312, question generator 314, answers generator 316, affirmative sentence generator 318, reasoning sentence generator 320, and original question answer generator 322, along with control algorithms/logic 324, data storage 325, and LLM interface 226 to allow these components to automatically submit and receive prompts and responses to/from a LLM. These elements operate in conjunction with each other and as a pipeline for processing an original input question 311 in accordance with the algorithms and controls of the control algorithms/logic 324 of the MQARR system 300. The pipeline of these elements operates to generate an intermediate search space, which may be stored in the data storage 325, comprising an automatically generated relevant knowledge graph based on automated sub-question generation and answering, as discussed hereafter. Based on the intermediate search space and relevant knowledge graph, the original input question may be answered and the resulting answer 323 returned to the submitter of the original input question, e.g., a client computing device or the like (not shown).

It should be appreciated that while FIG. 3 shows the MQARR system 300 as being a separate entity from that of the LLM 340, but operating in conjunction with the LLM 340 via the data network(s) 330, the illustrative embodiments are not limited to such. To the contrary, the MQARR system 300 may be integrated with the LLM 340 and may, in some illustrative embodiments, be an additional computer logic that automatically executes in conjunction with the LLM 340 when it is determined that an original input question 311 is a multi-hop question. That is, if the question is submitted to the LLM 340, logic associated with the LLM 340 or the entity extractor 312 may perform an analysis of the question to determine what the question is asking, the focus of the question, how many entities are involved, and the like, to classify the question as a single hop or multi-hop question. A machine learning trained classification computer model may be employed to perform a classification of the features extracted from the input question to determine if the features represent a pattern indicative of a multi-hop question or not. For multi-hop questions, the processing via the MQARR system 300 may be invoked.

Thus, the original (or main) question 311 may be submitted to the LLM 340 and the MQARR system 300 automatically invoked when the original question 311 is determined to be a multi-hop question requiring the operation of the MQARR system 300 and the specific pipeline of components 312, 314, 316, 318, 320, and 322 to generate an accurate answer to the original question 311. Hence, depending on the desired implementation, the MQARR system 300 may be a separate entity or may be integrated with the LLM 340. For purposes of illustration, FIG. 3 shows the MQARR system 300 as a separate entity and thus, the following description will assume such a configuration.

The LLM interface 326 of the MQARR system 300 provides the logic, application programming interfaces (APIs), and other computing resources to facilitate interactions with a LLM 340 with regard to submitting requests and receiving responses from the LLM 340. It should be appreciated that in embodiments where the MQARR system 300 is integrated with the LLM 340, the interface 326 may not be necessary and its functionality may be part of other components of the LLM 340. The LLM 340 and the MQARR system 300 operate based on one or more corpora of electronic documents 350 that are accessible via the one or more data networks 330. These electronic documents 350 may take many different forms including various structured and unstructured forms, such as websites, web pages, files, data structures, and the like, accessible from one or more client computing devices, server computing devices, cloud computing service providers, or any other source computing and/or data storage system.

As shown in FIG. 3, the MQARR system 300 operates on an original (or main) question 311 that is provided by a question submitter. The question submitter may be a client computing device, e.g., desktop computer, portable computer, mobile communication device, or the like, through which a user submits a natural language question for answering by the LLM 340. The question may be submitted as spoken language that is converted to text or as original textual input. The MQARR system 300 and LLM 340 process the original input question 311 and generate an answer 323 that is returned to the question submitter. The answer to the question may be returned as a textual response, text which is then converted to an audio output, or the like. An example of an LLM 340 that processes questions and generates a response may be the Chat-GPT system which receives a textual input specifying a natural language question, and provides textual output that corresponds to an answer to the natural language question. The MQARR system 300 is specifically directed to improving the way in which such an LLM 340 generates the answer to the original input question 311, and specifically in the case of multi-hop questions which, as noted above, are not accurately answered by existing LLMs.

The illustrative embodiments improve the operation of the LLM 340 by providing a specific artificial intelligence pipeline comprising the components 312, 314, 316, 318, 320, and 322, as well as control algorithms/logic 324, data storage 325, and LLM interface 326. Assuming that the original question 311 is a multi-hop question, as may be determined from a classification computer model as noted above, for example, the following description will detail the way in which the pipeline of the MQARR system 300 operates to improve the answering capability of the LLM 340 by improving the accuracy of the answer generated by the LLM 340.

As shown in FIG. 3, the original question 311 is received in the MQARR system 300 and provided to an entity extractor 312. The entity extractor 312 is a component that processes the original question 311 and performs named entity recognition (NER) and natural language processing (NLP) to extract entities from the natural language content of the original question 311. In some cases, the entity extractor 312 may utilizes resources of the LLM 340 to perform such NER and NLP. The entity extractor 312 is a component that takes a sentence s as input and returns the main entities that appear in that sentence, i.e., εₛ [symbol] {E₀, . . . , Eₙ}. Thus, for example, the entity extractor 312 may operate on the original (main) question 311 and generate a context and extracted entities 313, e.g., “Context: <<main question>>, Extracted entities: entity 1, entity 2, etc.”

The entities 313 extracted from the original question 311 by the entity extractor 312 are input to the question generator 314. The question generator 314 uses the entities 313 to construct one or more sub-questions whose answer will assist in answering the original question. In some illustrative embodiments, these sub-questions are constructed from predefined templates that corresponding to what is referred to herein as a “WH-question”, meaning that the sub-question asks one of the questions of “What”, “Where”, “Who”, “Which”, “Why”, “When”, or “How”. Such “WH-questions” are the focus of the question generator 314 because they usually only inquire about one new knowledge element at a time for a given entity. The sub-questions 315 may have multiple of the same “WH” word based questions, but with each being a different question, e.g., multiple “What” sub-questions asking different questions, multiple “Where” sub-questions asking different questions, or the like. Thus, each sub-question will be starting from a WH-question word.

The question generator G_{Q} 314 is a component that takes the original (main) question Q 311, a set of current knowledge S_{K} extracted from the LLM 340's knowledge space T, and an entity Eᵢ, and returns a set of questions {q₀, . . . , qₙ} related to that entity that should help in answering Q, i.e., G_{Q}(Eᵢ, Q, S_{K}) [symbol] {q₀, . . . , qₙ}. The set of current knowledge S_{K} represents the knowledge that has been accumulated by answering the question generated by question generator Go 314 and thus, evolves as iterations of answering are performed, as discussed hereafter. The question generator 314 may operate in conjunction with the LLM 340 via the LLM interface 326 to construct this set of questions using diverse WH-question word construction logic from the MQARR system 300 and the extracted entities. That is, to generate these “WH” question word based sub-questions, the “WH” question word, e.g., What, Where, Who, Which, Why, How, etc., is concatenated with the current knowledge and a prompt requesting the generation of a sub-question. Again, the current knowledge is the knowledge presently obtained from the process of generating the relevant knowledge graph via the mechanisms of the illustrative embodiments. The operation of the elements 312-316 may be part of the generation of a relevant knowledge graph as an intermediate search space having only the relevant knowledge from the larger knowledge base T used by the LLM 340, such as obtained from the corpus 350.

The generation of the relevant knowledge graph may be performed using the following process. At an initial time step t=0, the entities 313 are extracted by the entity extractor 312 from the original (main) question 311, as noted above. Then, for each entity Eᵢ, a set of sub-questions 315 are generated by the question generator 314. At time step t=0, the current knowledge S_{K}=0. Each question q initiates a new node in the relevant knowledge graph, where each node specifies a tuple (q, a_{q}, answer, entity in answer), where a_{q} is the score returned by a question ranker of the question generator 314. Initially, the answer=Null and the entity in the answer=Null.

With regard to the question ranker, the question generator 314 may implement the question ranker R_{Q} which takes the original (main) question Q, a set of current knowledge S_{K}, an entity Eᵢ, and a question q about this entity, and returns a scalar a_{q}∈ [symbol] ₊ that describes how well q helps answering Q using S_{K} and Eᵢ, i.e., R_{Q}(Eᵢ, Q, S_{K}, q) [symbol] α_{q}. In some illustrative embodiments, this scalar is a perplexity weighting value. Thus, each sub-question is weighted by a perplexity weighting value that is a function that generates a metric indicative of how confident a model is in the prediction it generates. In the present case, the perplexity is a measure of how confident the question generator 314 is in the sub-question providing an answer that will help answer the original input question. The perplexity metric in the illustrative embodiments serves as a basis for selecting sub-questions for generation of the relevant knowledge tree of the intermediate search space. In some illustrative embodiments, the perplexity may be calculated using the following relationship:

$$perplexity ( {y}_{n} , … , {y}_{0} ) = \frac{1}{n} {\sum }_{i = 1}^{n} - log ( p ( {y}_{i} \vert {y}_{i - 1} , … , {y}_{0} ) ) ,$$

where y is a token in a sentence and is indexed by n, and p is the probability returned by the LLM knowing the previous token. For example, for the question “where are you born?”, the tokens may be y0=where, y1=are, y2=you, and y3=born?, and the probability p is the probability of having the token “you” following “where are”. Thus, the perplexity is the average probability in the generated sentence.

After the initialization of the relevant knowledge graph as above, at each time step t of the operation, the following operations are repeated. Going down each branch of the relevant knowledge graph, following at each node the questions with the higher score a, or perplexity, meaning that there is a higher confidence that the answer to the sub-question corresponding to the node will help with answering the original or main question Q 311. This is done until a leaf node is reached. The leaf node of the relevant knowledge graph is either a question not answered yet or a question successfully answered. In the case of a question that has been answered successfully, the question generator Ge 314 generates and ranks Re a new set of questions about an entity in the leaf. In the case of a question that is not answerable, i.e., one that has no relevant information that can be found in a knowledge dataset D_{KG}, the node is “turned off” by setting its score to 0, meaning it will not continue to grow the relevant knowledge graph. At a next growing step, the question with the second highest score in the previous node will be used instead. The knowledge dataset D_{KG} represents knowledge from an established knowledge source, e.g., a known database of information or website such as Wikipedia™, one or more predefined knowledge graphs, ontologies, or any other source of predefined knowledge represented as data structures which may serve as a source of information for answering questions via the LLM 340.

Each selected question in each branch of the relevant knowledge graph is passed to the answer generator 316. From the returned answers 317, the corresponding entity is extracted, and the current node is completed in the relevant knowledge graph. At the end of a growing step, the current relevant knowledge graph, or tree T, is evaluated to determine if the growing of the relevant knowledge graph or tree T meets a growth stopping criterion, e.g., the current knowledge G_{S}(Q, T) is greater than 0.5. If not, the operation is repeated to expand the relevant knowledge graph or tree T. Once the relevant knowledge graph or tree T is built through such a process, the answer to the original (main) question is obtained by taking the return of the final answer function A(Q, T) that returns a sequence of tokens y.

Thus, during this process of building the relevant knowledge graph or tree T, the question generator 314 may pass to the LLM 340 an input request text of the form: “Prompt+You know that: S_{K}. You have to answer the main question: Q. You have to decompose the reasoning step by step. Write a useful question about E; to help answer the main question: Wh”, where Q is the original (or main) multi-hop question, S_{K} is the knowledge in the current branch so far in the relevant knowledge graph, Eᵢ is the current entity on which to generate questions, and Wh is a “WH-question word”. S_{K} is obtained by concatenating the answer collected when one goes from the root of the relevant knowledge graph to the entity Eᵢ. The above is an example of a sub-question generation prompt that may be submitted to the LLM 340 to get the LLM 340 to generate one or more sub-questions that can be used to assist with answering the main question, i.e., the original multi-hop question.

The sub-questions 315 are input to the answers generator 316 which processes the sub-questions 316 using the LLM 340. The answers generator G_{A} 316 takes a sub-question q and a knowledge dataset D_{KG} and returns a sequence of tokens {y₀, . . . , yₙ} that corresponds to the answer of the question, i.e., G_{A} (q, D_{KG})→{y₀, . . . , yₙ}. In some illustrative embodiments, the knowledge dataset D_{KG} is a knowledge graph, such as a corpus 350, which is used to answer the WH-questions generated by the LLM 340. To extract the relevant information from the knowledge dataset D_{KG} the illustrative embodiments look at a representation of the knowledge dataset D_{KG} projected into an embedding space and project the sub-questions q into the same embedding space. The illustrative embodiments retrieve the k documents (from the knowledge dataset D_{KG}) that are the closest to the question in that embedding space. The relevant documents and the sub-question are passed to the answer generator 322.

The sequence of tokens, e.g., the tokens y noted previously, represent the answer to the sub-question q. As explained above y0, . . . , yn are the tokens generated by the LLM 340 that can be used to generate a question or generate an answer. When these tokens are combined, one can generate either the question or the answer. Each time the LLM 340 generates a token, it also returns a probability of this token knowing the previously generated tokens, as mentioned above. The perplexity weighting score is the arithmetic means of the log probability of all the tokens composing the sentence generated by the LLM 340.

This may be performed for each sub-question to generate a set of answers 317. For example, the answers generator 316 may, via the LLM 340, gather context for related documents from the corpora 350, such as a source present in the corpora 350, e.g., Wikipedia or the like, and may then ask the LLM 340 to respond to the request “Please answer the question using the context provided. If the question is unanswerable, say unanswerable. Question: <<sub-question>> Context: <<context>> Answer:” where the “<<sub-question>>” is the sub-question 315 generated by the question generator 314 and the context specifies the information, or an identifier of the sources of information, e.g., Wikipedia™, an ontology, or other database of information, given to the LLM 340 for generating an answer. The answer generator 316 generates and returns the “Answer” in this request, which may be a answer generation prompt of the form above, for example. This may be performed with regard to each sub-question 315 generated by the question generator 314.

The answers 317 are input to the affirmative sentence generator 318 which is a component that converts the answers 317 into affirmative sentences. In this way the answers 317 are converted from a question-answer form that is presented by the LLM 340 by identifying entities present in the answer of the sub-question and constructing them into a natural language sentence specifying the answer. For example, an affirmative sentences of “Vatroslav Mimica directed the Falcon” can be generated from the LLM 340 generated answer: ““Who is the director of the Falcon?” Answer: Vatroslav Mimica”. This may be accomplished by submitting the answers 317 along with a request of the type “Question: <<sub-question>>, Answer: <<entities from answer>>, Affirmative Sentence:” to the LLM 340 by the affirmative sentence generator 318 using a specifically crafted prompt that elicits greater performance by the LLM 340, e.g., an affirmative sentence generation prompt of the type corresponding to the request above. That is, the affirmative sentence generator 318 may generate affirmative sentences 319 using specifically designed prompts, such as the sentence example above, which are submitted to the LLM 340, for example. It should be appreciated that even if LLMs 340 are exceptionally good at modeling language, some ways of presenting a task (for instance generating a question), or the particular information upon which to operate to accomplish the task, will assist the LLM 340 in generating more accurate outputs. Finding such input is referred to as prompt design (the prompt is what is input to the LLM 340). In order to have reliable output, templated prompts, such as the sentence noted above, may be provided by the affirmative sentence generator 318, with added specific information (for instance the answers 317), to perform the specific task required, e.g., affirmative sentence generation in this example.

Thus, the affirmative sentence generator 318 may operate in conjunction with the LLM 340 to generate the affirmative sentence(s). The LLM 340 is a deep neural network that has been trained to model language. The training consist of predicting the next token of a sentence. The LLM 340, which may operate on hundreds of millions or billions of parameters, are trained on billions of sentences scraped from various sources, e.g., internet websites. Thus, LLM 340 is able to model language and gain many emerging properties. The affirmative sentence generator 318 may generate prompts to the LLM 340 to assist in the generation of the affirmative sentences leveraging its training with regard to the modeled language.

The affirmative sentences 319 are input to a reasoning sentence generator 320 which generates a reasoning sentence 321 from the affirmative sentences 319 leveraging the properties of the LLM 340 to formulate the reasoning sentence 321 from the affirmative sentences 319. For example, a sentence of the type “You have to answer the main question using only the context: <<main question>> Context: <<affirmative sentences>> Reasoning: to answer the main question we need to find in the context” may be generated and submitted to the LLM 340, such that the LLM 340 returns the reasoning sentence 321. Similar to the affirmative sentences 319 above, the reasoning sentences 321 may be generated in response to specifically designed prompts, i.e., reasoning sentence templated prompts such as the sentence example above, generated by the reasoning sentence generator 320 which are then submitted to the LLM 340, for example. Again, the way of presenting a task (for instance generating a question), or the particular information upon which to operate to accomplish the task, will assist the LLM 340 to generate better outputs, and the reasoning sentence generator 320 provides a specific way of presenting the task and additional information to achieve improved performance of the LLM 340. In order to have reliable output, similar to the affirmative sentence generator 318, the reasoning sentence generator 320 may also implement templated prompts, such as the sentence noted above, which are provided by the reasoning sentence generator 320, with added specific information (for instance knowledge from a database), to perform the specific task required, e.g., reasoning sentence generation in this example.

The reasoning sentence 321 is input to the original question answer generator 322 which implements a check function to determine whether the main question can be answered or not. The check function, for example, uses one or more sentences which end in “Yes” or “No”, and which are then input to the LLM 340. The LLM 340 returns the probability of “Yes” or “No” for the sentence, and the probability is used to determine if the original question 311 can be answered, e.g., the probability is equal to or above a predetermined threshold. For example, these sentences can be of the type “You have to answer the main question using only the context: <<main question>> Context: <<affirmative sentences>> Reasoning: to answer the main question we need to find in the context <<reasoning>> Is it possible to answer the main question using only the context? Yes”, where this is a check templated prompt. In response to this sentence input to the LLM 340, the LLM 340 returns a probability that the original question (main question) 311 can or cannot be answered from the context, which is the set of affirmative sentences 320, using the reasoning of the reasoning sentence 321.

If the original question cannot be answered, the relevant knowledge graph or tree T is grown using different entities of the original multi-hop question. If the original question answer generator 322 determines that the original question 311 can be answered, the answer is extracted by the LLM 340. Extracting the final answer may be done by submitting a request to the LLM 340 of the type “Please answer the question using the context provided. Question: <<main question> Context: <<affirmative sentences>> Reasoning: to answer the main question we need to find in the context <<reasoning>> Question: <<main question>>”, where this may be considered a final answer prompt submitted to the LLM 340.

Thus, the illustrative embodiments provide an improved computing tool and improved computing tool operations/function to improve the answering of multi-hop questions by a LLM. The illustrative embodiments provide specific mechanisms for generating sub-questions and answers to these sub-questions which builds an intermediate search space with a relevant knowledge graph that can be used to answer the original input question. The illustrative embodiments provide a pipeline of components that operate to generate specific textual request inputs to a LLM through a series of operations that results in the LLM being able to generate a more accurate answer for the original question. These specific textual requests target the automatically generated questions, answers, and contexts and generate a relevant corpus from which the original question can be answered with sufficient accuracy rather than perform LLM question answering on general large knowledge bases.

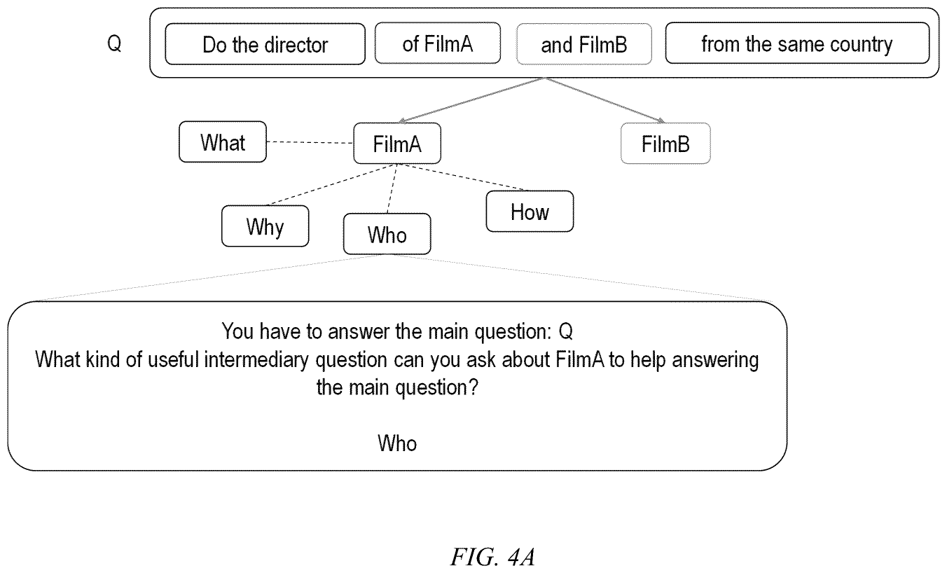

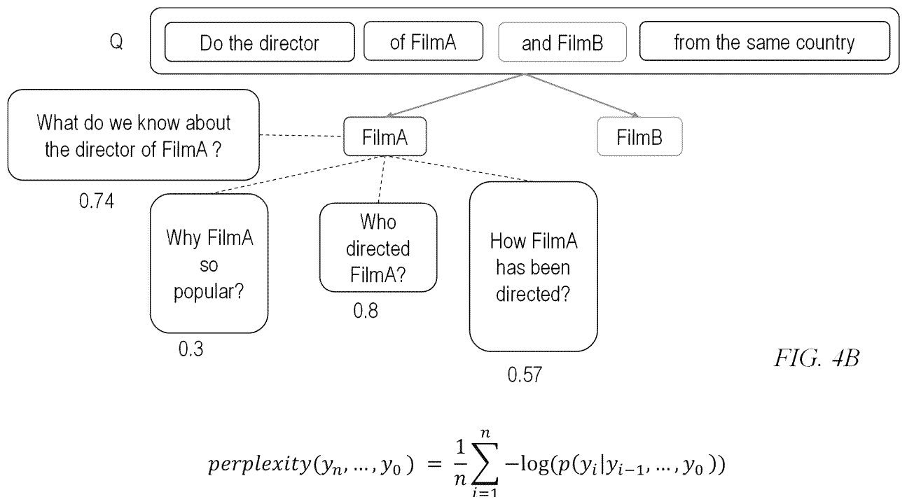

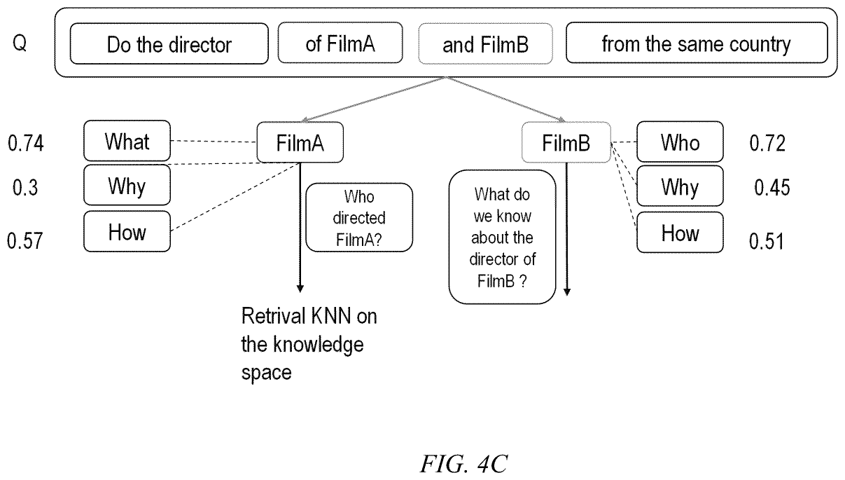

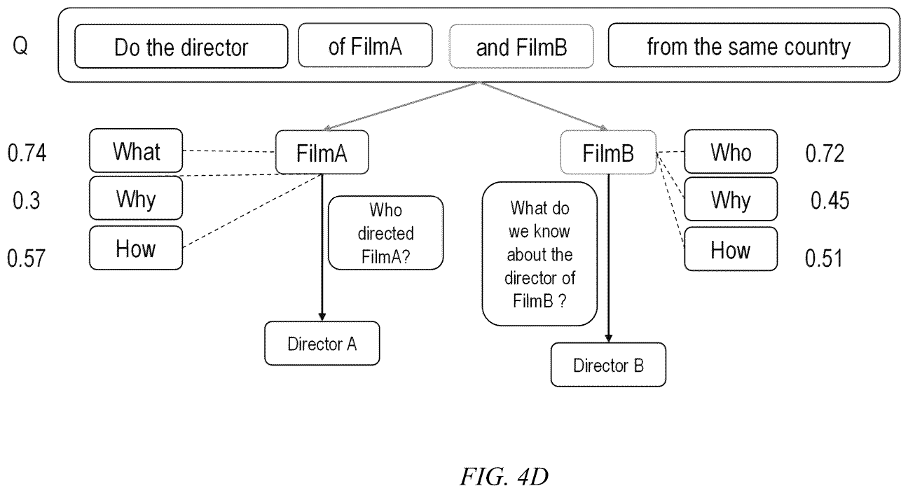

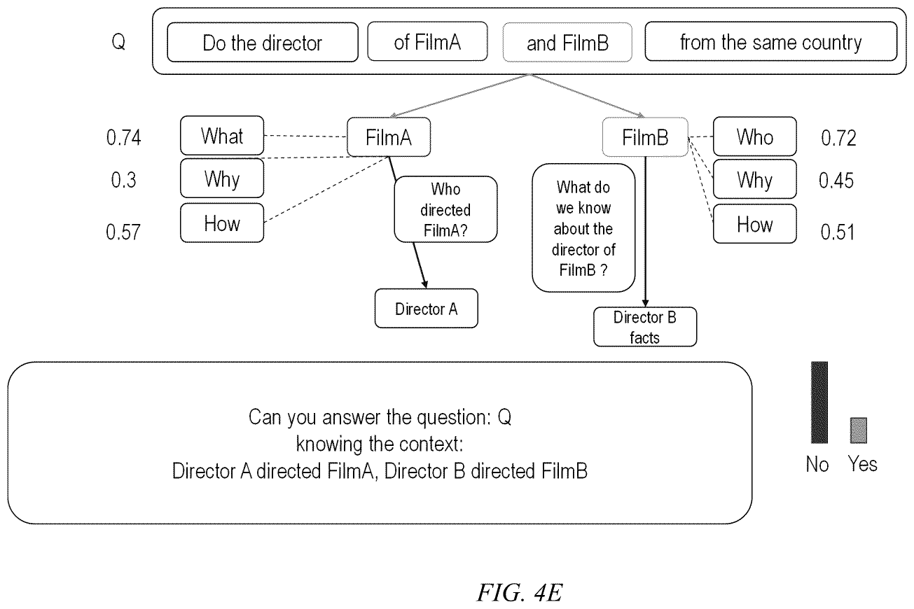

FIGS. 4A-4E are example diagrams illustrating the operation of a multi-hop question answer retrieval and reasoning (MQARR) system with regard to one example original question, in accordance with one illustrative embodiment. As shown in FIG. 4A, an original question in this example may be of the type “Do the director of Film A and Film B come from the same country?”. Performing an entity extraction operation on this question one obtains directory, Film A, Film B, and country as entities, and natural language processing determines that the question focus type is that of a person. As shown, for each entity, e.g., Film A, a plurality of “WH-questions” may be generated. Thus, for example, for the “Who” question, the automatic generation of sub-questions may involve the question generator formulating a textual request input to the LLM of the type shown, e.g., “You have to answer the main question: Q What kind of useful intermediary question can you ask about Film A to help answer the main question? Who”. This may be performed for each type of “WH-question” with differing sub-questions being generated for each of the “WH-questions”.

That is, the prompt above may be submitted to the LLM, e.g., LLM 340, which, based on its trained ability to model text and language, processes the prompt and generates the requested result. In this prompt, the LLM 340 is requested to generate sub-questions that will assist in the answering of the original (or main) multi-hop question. In addition, the first word of a WH-question is added in order to push the LLM 340 to generate such a type of question (the LLM 340 completes the sentence taking into account the previous words thus completing the WH-question). The use of WH-questions is a way to restrict the LLM 340 to a subgroup of questions, still being sufficiently flexible to extract relevant information. The modeling abilities of the LLM 340 generate an intermediary question about the entity that aligns with the original (or main) multi-hop question.

As shown in FIG. 4B, various “WH-questions” are generated, such as “What do we know about the director of Film A?”, “Why Film A so popular?”, “Who directed Film A?”, “How Film A has been directed?”. Each sub-question is evaluated to determine a relative confidence that the sub-question will help in answering the original question. In some illustrative embodiments, this relative confidence is represented by a perplexity or score, as previously discussed above. For example, as shown in FIG. 4B, the question “Who directed Film A?” has a relatively highest score or perplexity, which indicates a greater confidence that this sub-question will aid in answering the original question. Thus, when building the relevant knowledge graph, the node associated with this sub-question will be selected and traversed to grow the relevant knowledge graph through sending of the selected sub-question to the LLM as discussed above and shown in FIG. 4C.

As shown in FIG. 4C, this is done for each entity and highest scoring node. Thus, when evaluating the entity Film B, it is determined that the sub-question “What do we know about the director of Film B?” is highest scoring and likely to aid in answering the original question. Thus, this sub-question is submitted to the LLM for answering and growing the relevant knowledge graph, such as shown in FIG. 4D where the answers are Director A and Director B for the sub-questions associated with Film A and Film B.

Having generated the answers for these sub-questions to thereby grow the relevant knowledge graph. Having grown the graph, the system then determines if the original question can be satisfactorily answered from the grown knowledge graph. For example, a textual request may be submitted by the illustrative embodiments to the LLM which may have the format of “Can you answer the question: Q knowing the context: Direct A directed Film A, Director B directed Film B” or the like. A determination of a probability of Yes and/or No is generated, which in this case, as shown, has a higher probability that the original question cannot be answered from the current context of the relevant knowledge graph. Thus, in this case, the process would be repeated with other entities, such as additional facts about Director A and/or Director B, as entities to thereby extend the relevant knowledge graph from the existing nodes of the relevant knowledge graph. This process may continue until the answer to the question in FIG. 4E is more probably “Yes”.

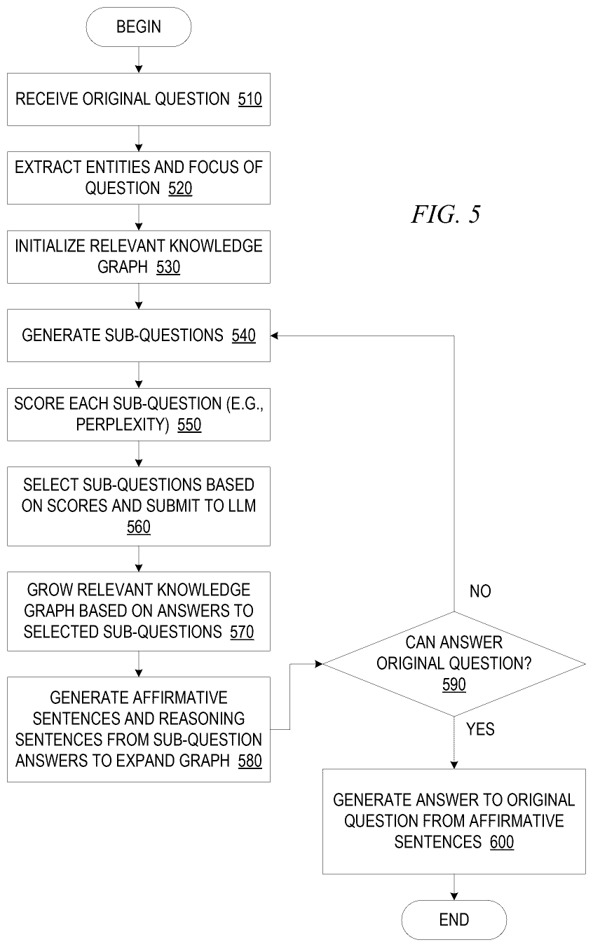

FIG. 5 presents a flowchart outlining example operations of elements of the present invention with regard to one or more illustrative embodiments. It should be appreciated that the operations outlined in FIG. 5 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 5, and may, in some cases, make use of the results generated as a consequence of the operations set forth in FIG. 5, the operations in FIG. 5 themselves are specifically performed by the improved computing tool in an automated manner.

As shown in FIG. 5, the operation starts by receiving an original question (step 510). The original question is parsed and processed to extract entities and determine the focus of the question, i.e. what type of answer is being sought by the original question (step 520). Initialize relevant knowledge graph (step 530) and generate sub-questions (step 540). Score each sub-question based on likelihood to aid in answering original question, e.g., generate perplexity score for the sub-question (step 550). Select sub-questions based on scores and submit to LLM (Step 560). Grow relevant knowledge graph based on answers to selected sub-questions (step 570). The answers to the sub-questions are used go generate affirmative sentences and resonating sentences which are used to expand the intermediate search space comprising the relevant knowledge graph (step 580). A determination is made as to whether the current state of the relevant knowledge graph is sufficient to answer the original question (step 590). If not, the operation returns to step 540 where additional sub-questions for another entity are generated and the process repeats. If the question can be answered, then the question answer is generated from the affirmative sentences using the LLM (step 600). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for answering a multi-hop question by an artificial intelligence (AI) computer model, the computer-implemented method being executed by a multi-hop question answer retrieval and reasoning (MQARR) system associated with the AI computer model, the method comprising:
extracting, by an entity extractor of the MQARR system, one or more entities included in the multi-hop question;
generating, by a question generator of the MQARR system, for each entity, a plurality of sub-questions to assist answering the multi-hop question;
obtaining, from the AI computer model, for each sub-question for each entity, a corresponding answer to the sub-question from a knowledge base;
converting, by an affirmative sentence generator of the MQARR system, each pair of sub-question and corresponding answer to a corresponding affirmative sentence for the pair, to thereby generate a plurality of affirmative sentences;
generating, by a reasoning sentence generator of the MQARR system, one or more reasoning sentences to answer the multi-hop question based on the plurality of affirmative sentences;
determining, by the MQARR system, whether the multi-hop question is answerable or not based on the one or more reasoning sentences; and
in response to determining that the multi-hop question is answerable based on the one or more reasoning sentences, generating, by the MQARR system, an answer to the multi-hop question based on the one or more affirmative sentences and the one or more reasoning sentences.

2. The computer-implemented method of claim 1, wherein:
each of the plurality of sub-questions for each entity starts with one of a What, Where, Who, Which, When, Why, or How question term,
each of the plurality of sub-questions for each entity is weighted by a corresponding perplexity weighting score indicating how helpful the sub-question is to answering the multi-hop question, and
obtaining a corresponding answer to each sub-question includes, for each entity, determining a sub-question having a relatively highest perplexity weighting score of the sub-questions for that entity, and obtaining an answer to the sub-question having the relatively highest perplexity weighting score.

3. The computer-implemented method of claim 2, further comprising in response to a determination that the multi-hop question is not answerable based on the one or more reasoning sentences, obtaining an answer to the sub-question with a next highest perplexity weighting score and iterating subsequent processes.

4. The computer-implemented method of claim 1, wherein obtaining an answer to each sub-question is performed by using a large language model and templated prompts, generated by the MQARR system, and submitted by the MQARR system to the large language model.

5. The computer-implemented method of claim 4, wherein the templated prompts comprise a sub-question generation templated prompt, submitted to the AI computer model by the question generator of the MQARR system, specifying the multi-hop question, a current state of a relevant knowledge graph, a current entity in the one or more entities for which to generate sub-questions, and one or more question words to use for generating the sub-questions.

6. The computer-implemented method of claim 4, wherein the templated prompts comprise an affirmative sentence templated prompt, submitted to the AI computer model by the affirmative sentence generator of the MQARR system, specifying a sub-question corresponding to an entity in the multi-hop question, answer entities in answers to the sub-question, and a request to generate an affirmative sentence based on the sub-question and the answer entities in answers to the sub-question.

7. The computer-implemented method of claim 4, wherein the templated prompts comprise a reasoning sentence templated prompt, submitted to the AI computer model by the reasoning sentence generator of the MQARR system, specifying the multi-hop question, a context comprising the plurality of affirmative sentences generated by the affirmative sentence generator, and a request to answer the multi-hop question based on the plurality of affirmative sentences.

8. The computer-implemented method of claim 4, wherein the templated prompts comprise a check templated prompt, submitted to the AI computer model by the MQARR system, specifying the multi-hop question, a first context comprising the plurality of affirmative sentences, and a second context specifying the one or more reasoning sentences, and requesting a probability that the multi-hop question can be answered based on the first context and the second context.

9. The computer-implemented method of claim 1, further comprising generating a relevant knowledge graph data structure comprising, for each sub-question in the plurality of sub-questions, a corresponding node comprising a tuple having the sub-question, an answer to the sub-question, an entity in the answer to the sub-question, and a perplexity weighting score that indicates how well the sub-question assists in answering the multi-hop question.

10. The computer-implemented method of claim 6, wherein obtaining, from the AI computer model, for each sub-question for each entity, a corresponding answer to the sub-question from a knowledge base comprises growing a tree data structure of the relevant knowledge graph at least by:
iteratively traversing each branch of the relevant knowledge graph following nodes with a relatively higher perplexity weighting score until a leaf node is reached; and
during the iterative traversing, in response to reaching a node with an unanswered sub-question:
submitting the unanswered sub-question to the AI computer model for answering to generate the corresponding answer to the sub-question; and
completing the tuple for the reached node based on the corresponding answer.

11. A computer program product comprising a computer readable storage medium having a computer readable program stored therein, wherein the computer readable program, when executed in a data processing system, causes the data processing system to implement a multi-hop question answer retrieval and reasoning (MQARR) system that is associated with an artificial intelligence (AI) computer model, and wherein the MQARR system operates to:
extract, by an entity extractor of the MQARR system, one or more entities included in the multi-hop question;
generate, by a question generator of the MQARR system, for each entity, a plurality of sub-questions to assist answering the multi-hop question;
obtain, from the AI computer model, for each sub-question for each entity, a corresponding answer to the sub-question from a knowledge base;
convert, by an affirmative sentence generator of the MQARR system, each pair of sub-question and corresponding answer to a corresponding affirmative sentence for the pair, to thereby generate a plurality of affirmative sentences;
generate, by a reasoning sentence generator of the MQARR system, one or more reasoning sentences to answer the multi-hop question based on the plurality of affirmative sentences;
determine whether the multi-hop question is answerable or not based on the one or more reasoning sentences; and
in response to determining that the multi-hop question is answerable based on the one or more reasoning sentences, generate an answer to the multi-hop question based on the one or more affirmative sentences and the one or more reasoning sentences.

12. The computer program product of claim 11, wherein:
each of the plurality of sub-questions for each entity starts with one of a What, Where, Who, Which, When, Why, or How question term,
each of the plurality of sub-questions for each entity is weighted by a corresponding perplexity weighting score indicating how helpful the sub-question is to answering the multi-hop question, and
obtaining a corresponding answer to each sub-question includes, for each entity, determining a sub-question having a relatively highest perplexity weighting score of the sub-questions for that entity, and obtaining an answer to the sub-question having the relatively highest perplexity weighting score.

13. The computer program product of claim 12, further comprising in response to a determination that the multi-hop question is not answerable based on the one or more reasoning sentences, obtaining an answer to the sub-question with a next highest perplexity weighting score and iterating subsequent processes.

14. The computer program product of claim 11, wherein obtaining an answer to each sub-question is performed by using a large language model and templated prompts, generated by the MQARR system, and submitted by the MQARR system to the large language model.

15. The computer program product of claim 14, wherein the templated prompts comprise a sub-question generation templated prompt, submitted to the AI computer model by the question generator of the MQARR system, specifying the multi-hop question, a current state of a relevant knowledge graph, a current entity in the one or more entities for which to generate sub-questions, and one or more question words to use for generating the sub-questions.

16. The computer program product of claim 14, wherein the templated prompts comprise an affirmative sentence templated prompt, submitted to the AI computer model by the affirmative sentence generator of the MQARR system, specifying a sub-question corresponding to an entity in the multi-hop question, answer entities in answers to the sub-question, and a request to generate an affirmative sentence based on the sub-question and the answer entities in answers to the sub-question.

17. The computer program product of claim 14, wherein the templated prompts comprise a reasoning sentence templated prompt, submitted to the AI computer model by the reasoning sentence generator of the MQARR system, specifying the multi-hop question, a context comprising the plurality of affirmative sentences generated by the affirmative sentence generator, and a request to answer the multi-hop question based on the plurality of affirmative sentences.

18. The computer program product of claim 14, wherein the templated prompts comprise a check templated prompt, submitted to the AI computer model by the MQARR system, specifying the multi-hop question, a first context comprising the plurality of affirmative sentences, and a second context specifying the one or more reasoning sentences, and requesting a probability that the multi-hop question can be answered based on the first context and the second context.

19. The computer program product of claim 11, further comprising generating a relevant knowledge graph data structure comprising, for each sub-question in the plurality of sub-questions, a corresponding node comprising a tuple having the sub-question, an answer to the sub-question, an entity in the answer to the sub-question, and a perplexity weighting score that indicates how well the sub-question assists in answering the multi-hop question.

20. An apparatus comprising:
at least one processor; and
at least one memory coupled to the at least one processor, wherein the at least one memory comprises instructions which, when executed by the at least one processor, cause the at least one processor to implement a multi-hop question answer retrieval and reasoning (MQARR) system that is associated with an artificial intelligence (AI) computer model, and wherein the MQARR system operates to:
extract, by an entity extractor of the MQARR system, one or more entities included in the multi-hop question;
generate, by a question generator of the MQARR system, for each entity, a plurality of sub-questions to assist answering the multi-hop question;
obtain, from the AI computer model, for each sub-question for each entity, a corresponding answer to the sub-question from a knowledge base;
convert, by an affirmative sentence generator of the MQARR system, each pair of sub-question and corresponding answer to a corresponding affirmative sentence for the pair, to thereby generate a plurality of affirmative sentences;
generate, by a reasoning sentence generator of the MQARR system, one or more reasoning sentences to answer the multi-hop question based on the plurality of affirmative sentences;
determine whether the multi-hop question is answerable or not based on the one or more reasoning sentences; and
in response to determining that the multi-hop question is answerable based on the one or more reasoning sentences, generate an answer to the multi-hop question based on the one or more affirmative sentences and the one or more reasoning sentences.
